(19) United States
(12) Patent Application Publication
(10) Pub. No.: US 2026/0261986 A1
(43) Pub. Date: Sep. 3, 2026

(54) TECHNIQUES FOR RELIABLE COMMUNICATION BETWEEN WIRELESS EARBUDS IN A HIGH-INTERFERENCE SCENARIO

(71) Applicant: QUALCOMM Incorporated, San Diego, CA (US)

(72) Inventors: Dishant SRIVASTAVA, Bangalore (IN); Vishal AGARWAL, Bangalore (IN); Mayank BATRA, Cambridge (GB); Joel LINSKY, San Diego, CA (US)

(21) Appl. No.: 18/877,810

(22) PCT Filed: Aug. 11, 2023
(86) PCT No.: PCT/US2023/072109

§ 371 Date: Dec. 20, 2024

(30) Foreign Application Priority Data
Aug. 31, 2022 (IN) 202241049776

(51) Int. Cl. H04W 52/24; H04W 52/38

(52) U.S. Cl. CPC H04W 52/243; H04W 52/245; H04W 52/383

(57) ABSTRACT

Methods, systems, and devices for techniques for reliable communication between wireless earbuds in a high-interference scenario are described. In some aspects, a first wireless earbud may support a detection mechanism according to which the first wireless earbud may detect that a quantity of channels experiencing relatively low interference is less than a minimum quantity of channels expected to be used for communication between the first wireless earbud and a second wireless earbud. In accordance with the detection mechanism, the first wireless earbud may trigger a transmit power reduction and a corresponding reduction in the minimum quantity of channels (or a release of a constraint associated with a minimum quantity of channels) if the first wireless earbud detects that there is likely a subset of a set of originally selected channels are likely suitable (e.g., have low interference) for communication between the first wireless earbud and the second wireless earbud.

### CROSS REFERENCE

The present Application for Patent is a 371 national stage filing of International PCT Application No. PCT/US2023/072109 by SRIVASTAVA et al., entitled “TECHNIQUES FOR RELIABLE COMMUNICATION BETWEEN WIRELESS EARBUDS IN A HIGH-INTERFERENCE SCENARIO,” filed Aug. 11, 2023; and claims priority to Indian Patent Application No. 202241049776 by SRIVASTAVA et al., entitled “TECHNIQUES FOR RELIABLE COMMUNICATION BETWEEN WIRELESS EARBUDS IN A HIGH-INTERFERENCE SCENARIO,” filed Aug. 31, 2022, each of which is assigned to the assignee hereof and each of which is expressly incorporated by reference herein.

### BACKGROUND

The following relates to wireless communications, including techniques for reliable communication between wireless earbuds in a high-interference scenario.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets.

In some cases, Bluetooth communications may require enhanced quality of service. For example, successful bidirectional transmission of audio information for voice may have a relatively low tolerance for packet loss or timing issues. The link quality between two devices may affect the data rate used for communications (e.g., as poor link quality may be associated with reduced bitrates for more robust communications).

### SUMMARY

The described techniques relate to improved methods, systems, devices, and apparatuses that support techniques for reliable communication between wireless earbuds in a high-interference scenario. Generally, the described techniques provide for a dynamic reduction in a quantity of channels used for communication between two wireless earbuds when one or both earbuds measures a relatively high level of interference. In some implementations, an earbud may employ an algorithm or some other detection mechanism that, when a relatively high level of interference is measured, triggers the reduction in the quantity of channels. Different upper limit transmit powers may be associated with different minimum quantities of channels and, in some implementations, the earbud may reduce an upper limit transmit power to below a threshold transmit power in order to reduce the quantity of channels used for communication.

A method for wireless communication at a first wireless earbud is described. The method may include performing a signal strength measurement across a first set of multiple channels that are available for communications between the first wireless earbud and a second wireless earbud, detecting that one or more interference metrics associated with the first set of multiple channels satisfy an interference criterion in accordance with the signal strength measurement across the first set of multiple channels, reducing an upper limit transmit power for the communications between the first wireless earbud and the second wireless earbud in accordance with the one or more interference metrics satisfying the interference criterion, and communicating with the second wireless earbud using a frequency hopping across a second set of multiple channels in accordance with reducing the upper limit transmit power, where the second set of multiple channels is a subset of the first set of multiple channels.

An apparatus for wireless communication at a first wireless earbud is described. The apparatus may include a processor, memory coupled with the processor, and instructions stored in the memory. The instructions may be executable by the processor to cause the apparatus to perform a signal strength measurement across a first set of multiple channels that are available for communications between the first wireless earbud and a second wireless earbud, detect that one or more interference metrics associated with the first set of multiple channels satisfy an interference criterion in accordance with the signal strength measurement across the first set of multiple channels, reduce an upper limit transmit power for the communications between the first wireless earbud and the second wireless earbud in accordance with the one or more interference metrics satisfying the interference criterion, and communicate with the second wireless earbud using a frequency hopping across a second set of multiple channels in accordance with reducing the upper limit transmit power, where the second set of multiple channels is a subset of the first set of multiple channels.

Another apparatus for wireless communication at a first wireless earbud is described. The apparatus may include means for performing a signal strength measurement across a first set of multiple channels that are available for communications between the first wireless earbud and a second wireless earbud, means for detecting that one or more interference metrics associated with the first set of multiple channels satisfy an interference criterion in accordance with the signal strength measurement across the first set of multiple channels, means for reducing an upper limit transmit power for the communications between the first wireless earbud and the second wireless earbud in accordance with the one or more interference metrics satisfying the interference criterion, and means for communicating with the second wireless earbud using a frequency hopping across a second set of multiple channels in accordance with reducing the upper limit transmit power, where the second set of multiple channels is a subset of the first set of multiple channels.

A non-transitory computer-readable medium storing code for wireless communication at a first wireless earbud is described. The code may include instructions executable by a processor to perform a signal strength measurement across a first set of multiple channels that are available for communications between the first wireless earbud and a second wireless earbud, detect that one or more interference metrics associated with the first set of multiple channels satisfy an interference criterion in accordance with the signal strength measurement across the first set of multiple channels, reduce an upper limit transmit power for the communications between the first wireless earbud and the second wireless earbud in accordance with the one or more interference metrics satisfying the interference criterion, and communicate with the second wireless earbud using a frequency hopping across a second set of multiple channels in accordance with reducing the upper limit transmit power, where the second set of multiple channels is a subset of the first set of multiple channels.

Some examples of the method, apparatuses, and non-transitory computer-readable medium described herein may further include operations, features, means, or instructions for generating a channel map based on the signal strength measurement across the first set of multiple channels, where the channel map indicates a third set of multiple channels associated with a lowest level of interference relative to a remainder of the first set of multiple channels and indicates a respective interference level for each of the third set of multiple channels, and where detecting that the one or more interference metrics satisfy the interference criterion may be based on generating the channel map.

In some examples of the method, apparatuses, and non-transitory computer-readable medium described herein, detecting that the one or more interference metrics satisfy the interference criterion may include operations, features, means, or instructions for ordering the third set of multiple channels into a sequence in accordance with the respective interference level for each of the third set of multiple channels and calculating a difference between a greatest interference level of the third set of multiple channels and an interference level of a channel of the third set of multiple channels that may be associated with a configurable index value into the sequence.

In some examples of the method, apparatuses, and non-transitory computer-readable medium described herein, the one or more interference metrics satisfy the interference criterion in accordance with the difference satisfying a threshold difference.

In some examples of the method, apparatuses, and non-transitory computer-readable medium described herein, detecting that the one or more interference metrics satisfy the interference criterion may include operations, features, means, or instructions for determining that a greatest interference level of a channel of the third set of multiple channels satisfies a threshold interference level.

In some examples of the method, apparatuses, and non-transitory computer-readable medium described herein, detecting that the one or more interference metrics satisfy the interference criterion may include operations, features, means, or instructions for determining that a quantity of the third set of multiple channels may be equal to a lower limit quantity associated with an initial transmit power.

Some examples of the method, apparatuses, and non-transitory computer-readable medium described herein may further include operations, features, means, or instructions for indicating an adaptive frequency hopping algorithm to use the second set of multiple channels in accordance with the one or more interference metrics satisfying the interference criterion, where the second set of multiple channels may be a subset of the third set of multiple channels and generating a second channel map based on the signal strength measurement across the first set of multiple channels, where the channel map indicates that the second set of multiple channels may be associated with the lowest level of interference relative to the remainder of the first set of multiple channels.

In some examples of the method, apparatuses, and non-transitory computer-readable medium described herein, reducing the upper limit transmit power may include operations, features, means, or instructions for reducing the upper limit transmit power from a first value associated with a first lower limit quantity of channels for the communications between the first wireless earbud and the second wireless earbud to a second value associated with a second lower limit quantity of channels for the communications between the first wireless earbud and the second wireless earbud, where the second lower limit quantity of channels may be less than the first lower limit quantity of channels.

Some examples of the method, apparatuses, and non-transitory computer-readable medium described herein may further include operations, features, means, or instructions for performing a second signal strength measurement of signaling from the second wireless earbud to measure a distance between the first wireless earbud and the second wireless earbud, where detecting that the one or more interference metrics satisfy the interference criterion and reducing the upper limit transmit power may be based on the first wireless earbud and the second wireless earbud being within a threshold distance of each other.

In some examples of the method, apparatuses, and non-transitory computer-readable medium described herein, communicating with the second wireless earbud using the frequency hopping across the second set of multiple channels may include operations, features, means, or instructions for transmitting or receiving audio data packets, to or from the second wireless earbud, in accordance with the frequency hopping across the second set of multiple channels.

### BRIEF DESCRIPTION OF THE DRAWINGS

FIG. 1 shows an example wireless communications system that supports techniques for reliable communication between wireless earbuds in a high-interference scenario in accordance with aspects of the present disclosure.

FIG. 2 shows an example user deployment that supports techniques for reliable communication between wireless earbuds in a high-interference scenario in accordance with one or more aspects of the present disclosure.

FIG. 3 shows an example communication update that supports techniques for reliable communication between wireless earbuds in a high-interference scenario in accordance with one or more aspects of the present disclosure.

FIG. 4 shows an example process flow that supports techniques for reliable communication between wireless earbuds in a high-interference scenario in accordance with one or more aspects of the present disclosure.

FIGS. 5 and 6 show block diagrams of devices that support techniques for reliable communication between wireless earbuds in a high-interference scenario in accordance with one or more aspects of the present disclosure.

FIG. 7 shows a block diagram of an I/O controller that supports techniques for reliable communication between wireless earbuds in a high-interference scenario in accordance with one or more aspects of the present disclosure.

FIG. 8 shows a diagram of a system including a device that supports techniques for reliable communication between wireless earbuds in a high-interference scenario in accordance with one or more aspects of the present disclosure.

FIGS. 9 and 10 show flowcharts illustrating methods that support techniques for reliable communication between wireless earbuds in a high-interference scenario in accordance with one or more aspects of the present disclosure.

### DETAILED DESCRIPTION

In some wireless communications systems, a user may wear two wireless earbuds, at least one of which may have a Bluetooth connection to a controlling device, such as a cell phone or other user equipment (UE). In some scenarios, for example, a first earbud may establish a Bluetooth connection to the controlling device and the controlling device may transmit packets (e.g., audio data packets) to the first earbud. A second earbud, which may not have an established Bluetooth connection to the controlling device, may attempt to “sniff” packets sent from the controlling device to the first earbud and may use a relay link from the first earbud to the second earbud for any missed packets.

Communication using the relay link between the first earbud and the second earbud may include frequency hopping over at least a minimum quantity of channels, where such a minimum quantity of channels may be associated with an upper limit transmit power used by one or both of the earbuds. For example, a minimum quantity of channels may apply when a transmit power is greater than a threshold transmit power. In some scenarios, such as scenarios in which there is a relatively high level of interference from other wireless communications, there may be fewer channels having relatively low interference measurements than the minimum quantity of channels, which may result in the earbuds occasionally (due to the frequency hopping) communicating using channels having relatively high interference measurements. Such communication using channels having relatively high interference measurements may result in relay failures from the first earbud to the second earbud, which may adversely impact latency, data rates, and user experience.

In some implementations, a first wireless earbud may support a detection mechanism according to which the first wireless earbud may detect that a quantity of channels having relatively low interference is less than a minimum quantity of channels expected to be used for communication between the first wireless earbud and a second wireless earbud. Further, in accordance with the detection mechanism, the first wireless earbud may trigger a transmit power reduction and a corresponding reduction in the minimum quantity of channels (or a release of the minimum quantity of channels constraint) if the first wireless earbud detects, ascertains, or otherwise determines that there is likely a subset of channels that have relatively low interference measurements (e.g., such that a subset of a set of originally selected channels are likely suitable for communication between the first earbud and the second earbud). For example, if the first wireless earbud measures that a difference between a relatively high interference measurement of one of the originally selected channels and an interference measurement of a specific other of the originally selected channels is greater than a threshold difference, the first wireless earbud may reduce a transmit power to below a threshold transmit power and, correspondingly, reduce the minimum or lower limit quantity of channels expected to be used.

Particular implementations of the subject matter described in this disclosure can be implemented to realize one or more of the following potential advantages. For example, in accordance with reducing a transmit power and a quantity of channels to be used for communication between the first wireless earbud and the second wireless earbud when relatively high levels of interference are measured, the first wireless earbud may avoid transmitting or receiving via channels that have high interference measurements but would otherwise have been used (e.g., if the transmit power was not reduced and a previous minimum quantity of channels constraint still applied). As such, the first wireless earbud and the second wireless earbud may focus communication to channels having relatively low interference measurements, which may result in a greater likelihood for successful communication between the wireless earbuds. Accordingly, the first wireless earbud and the second wireless earbud may support greater data rates and lower latency, as well as greater power savings and longer battery life in accordance with potentially performing fewer retransmissions.

Aspects of the disclosure are initially described in the context of a multimedia system. Aspects of the disclosure are additionally illustrated by and described with reference to a user deployment, a communication update, and a process flow. Aspects of the disclosure are further illustrated by and described with reference to apparatus diagrams, system diagrams, and flowcharts that relate to techniques for reliable communication between wireless earbuds in a high-interference scenario.

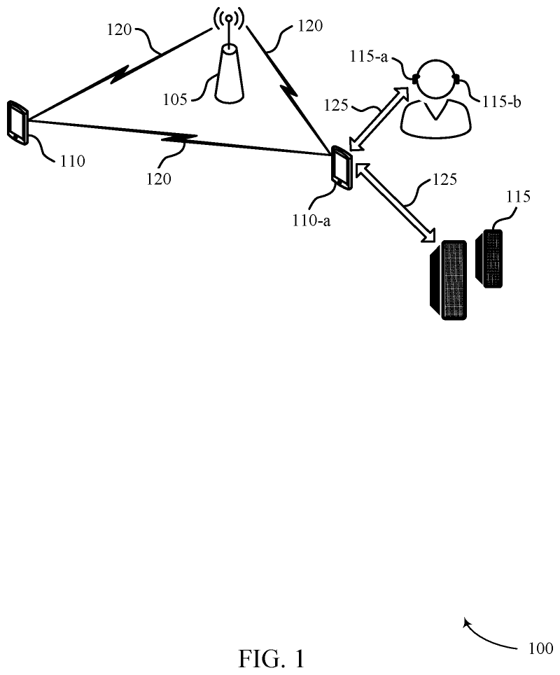

FIG. 1 illustrates an example of a wireless communications system 100 that supports techniques for reliable communication between wireless earbuds in a high-interference scenario in accordance with aspects of the present disclosure. In some examples, the wireless communications system 100 may include or refer to a wireless personal area network (PAN), a wireless local area network (WLAN), a Wi-Fi network) configured in accordance with various aspects of the present disclosure. The wireless communications system 100 may include an access point (AP) 105, devices 110 (e.g., which may be referred to as source devices, master devices, etc.), and paired devices 115 (e.g., which may be referred to as sink devices, slave devices, etc.) implementing WLAN communications (e.g., Wi-Fi communications) and/or Bluetooth communications. For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (e.g., such as devices 110), which may include wireless audio devices (e.g., headsets, earbuds, speakers, ear pieces, headphones), display devices (e.g., TVs, computer monitors), microphones, meters, valves, etc.

Bluetooth communications may refer to a short-range communication protocol and may be used to connect and exchange information between devices 110 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a master-slave relationship employing a time-division duplex protocol having, for example, defined time slots of 625 mu seconds, in which transmission alternates between the master device (e.g., a device 110) and one or more slave devices (e.g., paired devices 115). In some examples, a device 110 may generally refer to a master device, and a paired device 115 may refer to a slave device in the wireless communications system 100. As such, in some examples, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the wireless communications system 100. Generally, device 110 may refer to a wireless communication device capable of wirelessly exchanging data signals with another device (e.g., a paired device 115), and paired device 115 may refer to a device operating in a slave role, or to a short-range wireless communication device capable of exchanging data signals with the device 110 (e.g., using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (e.g., roles for a device 110 and a paired device 115) that together form a single use case called a profile (e.g., for communications between the device 110 and the paired device 115). One example profile defined in the Bluetooth specification is the Handsfree Profile (HFP) for voice telephony, in which one device (e.g., a device 110) implements an Audio Gateway (AG) role and the other device (e.g., a paired device 115) implements a Handsfree (HF) device role. Another example is the Advanced Audio Distribution Profile (A2DP) for high-quality audio streaming, in which one device (e.g., device 110) implements an audio source device (SRC) role and another device (e.g., paired device 115) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement mechanisms, repeat mechanisms, sequence numbering, scheduling behavior, etc.). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-less (ACL) links, (or ACL connections), synchronous connection orientated (SCO) links (or SCO connections), extended synchronous connection-oriented (eSCO) links (or eSCO connections), other logical transport channel links, etc.

In some examples, the controller stack may implement link management protocol (LMP) functions, low energy link layer (LELL) functions, etc. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some examples, the controller stack and the host stack may communicate via a host controller interface (HCI). In other cases, (e.g., for integrated devices such as Bluetooth headsets), the host stack and controller stack may be run on the same microprocessor to reduce mass production costs. For such host-less systems, the HCI may be optional, and may be implemented as an internal software interface.

A connection link 125 may be established between two Bluetooth-enabled devices (e.g., between a device 110 and a paired device 115) and may provide for communications or services (e.g., according to some Bluetooth profile). For example, a Bluetooth connection may be an eSCO connection for voice call (e.g., which may allow for retransmission), an ACL connection for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired device 115) are acknowledged, and may be retransmitted if not acknowledged during a retransmission window. In addition, audio may be streamed between a device 110 and a paired device 115 using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. In some cases the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within the wireless communications system 100, and devices may communicate with each other via communication links 120 (e.g., Wi-Fi Direct connections, Wi-Fi Tunneled Direct Link Setup (TDLS) links, peer-to-peer communication links, other peer or group connections). AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device 110) and uplink (e.g., the communication link from the device 110 to the AP 105).

In some examples, content, media, audio, etc. exchanged between a device 110 and a paired device 115 may originate from a WLAN. For example, in some examples, device 110 may receive audio from an AP 105 (e.g., via WLAN communications), and the device 110 may then relay or pass the audio to the paired device 115 (e.g., via Bluetooth communications). In some examples, certain types of Bluetooth communications (e.g., such as high quality or high definition (HD) Bluetooth) may require enhanced quality of service. For example, in some examples, delay-sensitive Bluetooth traffic may have higher priority than WLAN traffic.

In some aspects, a paired device 115 may include one or more earbuds, such as an wireless earbud 115-a and an wireless earbud 115-b. In some implementations, one or both of the wireless earbud 115-a and the wireless earbud 115-b may support a detection mechanism according to which one or both of the wireless earbud 115-a and the wireless earbud 115-b may detect that interference results in a quantity of channels having relatively low interference measurements being less than a minimum quantity of channels expected to be used for communication between the wireless earbud 115-a and the wireless earbud 115-b. For example, the wireless earbud 115-a and the wireless earbud 115-b, if using a transmit power greater than or equal to a threshold transmit power, may expect to use the minimum quantity of channels for communication between the wireless earbud 115-a and the wireless earbud 115-b.

Further, in accordance with the detection mechanism, one or both of the wireless earbud 115-a and the wireless earbud 115-b may trigger a transmit power reduction and a corresponding reduction in the minimum quantity of channels (or a releasing of the minimum quantity of channels constraint) if one or both of the wireless earbud 115-a and the wireless earbud 115-b detects, ascertains, or otherwise determines that there is likely a subset of channels that have relatively low interference measurements (e.g., such that a subset of a set of originally selected channels are likely suitable for communication between the wireless earbud 115-a and the wireless earbud 115-b). For example, if one or both of the wireless earbud 115-a and the wireless earbud 115-b measures that a difference between a relatively high interference measurement of one of the originally selected channels and an interference measurement of a specific other of the originally selected channels is greater than a threshold difference, one or both of the wireless earbud 115-a and the wireless earbud 115-b may reduce a transmit power to below a threshold transmit power and, correspondingly, reduce the minimum quantity of channels expected to be used (or release the minimum quantity of channels constraint).

The techniques described herein may provide improvements in reliability of communication between earbuds, such as between earbuds in scenarios in which one earbud relays audio data packets to the other earbud. Further, the techniques described herein may provide benefits and enhancements to the operation of the devices 110. For example, by increasing the reliability of relayed packets between wireless earbuds, the operational characteristics (such as power consumption, processor utilization, and memory usage) of the devices 110 may be reduced. The techniques described herein may also provide greater efficiency to the devices 110 by reducing latency associated with missed audio data packets and improve a user experience by providing a more seamless stream of audio to a user, among other benefits.

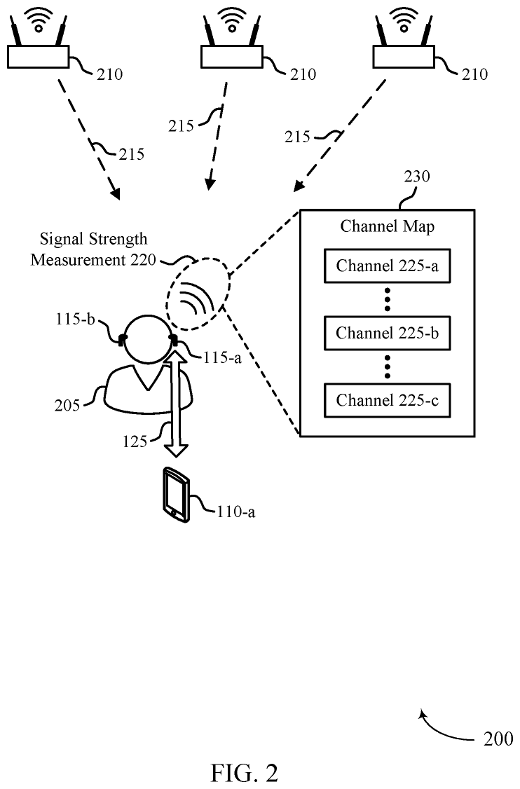

FIG. 2 illustrates an example user deployment 200 that supports techniques for reliable communication between wireless earbuds in a high-interference scenario in accordance with one or more aspects of the present disclosure. The user deployment 200 may implement or be implemented to realize or facilitate aspects of the wireless communications system 100. For example, the user deployment 200 illustrates communication between a device 110-a, an wireless earbud 115-a, and an wireless earbud 115-b, which may be examples of corresponding devices illustrated by and described with reference to FIG. 1. In some implementations, the wireless earbud 115-a or the wireless earbud 115-b, or both, may employ a procedure according to which the wireless earbud 115-a or the wireless earbud 115-b, or both, adjust communication between the wireless earbud 115-a and the wireless earbud 115-b to improve an audio quality for a user 205 in a presence of interference 215 from one or more other devices, such as one or more Wi-Fi devices 210.

In some aspects, the wireless earbud 115-a and the wireless earbud 115-b may be examples of mirroring earbuds, such as earbuds that support mirroring technology to facilitate robust, seamless connectivity for audio experiences. In accordance with mirroring technology, a primary earbud, such as the wireless earbud 115-a, may maintain a Bluetooth connection with the device 110-a (e.g., a smartphone of the user 205), while a secondary earbud, such as the wireless earbud 115-b, mirrors the connected primary earbud. For example, the secondary wireless earbud 115-b may attempt to “sniff” or otherwise receive packets transmitted from the device 110-a to the primary wireless earbud 115-a and, if the secondary wireless earbud 115-b misses a packet, the primary wireless earbud 115-a may relay the missed packet to the secondary wireless earbud 115-b. If a user removes the connected primary wireless earbud 115-a or if the primary wireless earbud 115-a depletes a power supply, the secondary wireless earbud 115-b may establish a Bluetooth connection with the device 110-a and become the primary earbud.

Additionally, or alternatively, if a potential connection between the device 110-a and the secondary wireless earbud 115-b is stronger than the connection between the device 110-a and the primary wireless earbud 115-a, the device 110-a, the wireless earbud 115-a, and the wireless earbud 115-b may coordinate such that the wireless earbud 115-b becomes the primary earbud and the wireless earbud 115-a becomes the secondary earbud. Further, the wireless earbud 115-a and the wireless earbud 115-b may be associated with a single Bluetooth address, such that one device appears when a user is pairing the wireless earbud 115-a and the wireless earbud 115-b to the device 110-a. Although either of the wireless earbud 115-a and the wireless earbud 115-b may function as the primary earbud at a given time, the user deployment 200 is illustrated and described in the context of the wireless earbud 115-a being the primary earbud and the wireless earbud 115-b being the secondary earbud.

In some deployment scenarios, such as in scenarios in which one or both of the wireless earbud 115-a and the wireless earbud 115-b are located nearby (e.g., proximate to, or within a threshold distance from) one or more other devices that are capable of communicating wirelessly, one or both of the wireless earbud 115-a and the wireless earbud 115-b may experience interference from the one or more other devices. For example, one or both of the wireless earbud 115-a and the wireless earbud 115-b may be located nearby one or more Wi-Fi devices 210 (which may be examples of APs) and the one or more Wi-Fi devices 210 may cause interference 215 to one or both of the wireless earbud 115-a and the wireless earbud 115-b.

In the example scenario illustrated by the user deployment 200, three Wi-Fi devices 210 (e.g., three APs) may each communicate (e.g., transmit or receive, or both) data traffic using different 20 MHz bands. In such examples, the use of three different 20 MHz bands by the three Wi-Fi devices 210 may result in bandwidth and system congestion such that there may be little room for “good” channels 225, such as channels 225 that are not used by the Wi-Fi devices 210 and otherwise not impacted by interference 215 from at least one of the Wi-Fi devices 210. As such, if the user 205 (e.g., a person) wearing the wireless earbud 115-a and the wireless earbud 115-b approaches the Wi-Fi devices 210 (e.g., becomes within a threshold distance from at least one of the Wi-Fi devices 210), a quantity of glitches (or glitching) at one or both of the wireless earbud 115-a or the wireless earbud 115-b may increase. For example, the quantity of glitches (or glitching) may be relatively less when the user 205 is 5 meters from the Wi-Fi devices 210 and may generally increase as the use 205 moves closer to the Wi-Fi devices 210 (e.g., as the user 205 approaches 0 meters from the Wi-Fi devices 210).

In some aspects, the quantity of glitches (or glitching) that the wireless earbud 115-a and the wireless earbud 115-b experience may depend on an orientation of the user 205. For example, the quantity of glitches may depend on whether the user 205 is associated with a 0 degree orientation (e.g., such that the user 205 is facing the Wi-Fi devices 210), a 90 degree orientation (e.g., such that the primary wireless earbud 115-a is facing the Wi-Fi devices 210), a 270 degree orientation (e.g., such that the secondary wireless earbud 115-b is facing the Wi-Fi devices 210), or a 180 degree orientation (e.g., such that a back of the user 205 is facing the Wi-Fi devices 210). In some examples, a quantity of glitches or glitching at the 90 and 180 degree orientations may be approximately the same if a link quality-based handover occurs via which the primary earbud becomes the secondary earbud, and vice versa.

In scenarios in which the wireless earbud 115-a and the wireless earbud 115-b are experiencing interference 215, the secondary wireless earbud 115-b may experience a greater quantity of glitches (or glitching) as compared to the primary wireless earbud 115-a. Such a greater error rate at the secondary wireless earbud 115-b may be due to latency or constraints associated with mirroring technology synchronization, a delivery-of-packets mechanism to the host (e.g., the device 110-a) or a difference in interference 215 at the secondary wireless earbud 115-b as compared to the primary wireless earbud 115-a, among other possible issues. Additionally, or alternatively, a greater error rate at the secondary wireless earbud 115-b may be due to a compounding effect across multiple piconets. For example, a relay piconet between the wireless earbud 115-a and the wireless earbud 115-b may suffer from the same packet loss issues as a piconet between the wireless earbud 115-a and the device 110-a (e.g., a packet loss rate on both piconets may be similar), so the joint effect may be relatively more on the secondary wireless earbud 115-b. Further, latency (e.g., a late arrival of packets at one or both of the primary wireless earbud 115-a and the secondary wireless earbud 115-b) may be proportional (e.g., directly proportional) to an effort that the primary wireless earbud 115-a spends to receive a media packet from the device 110-a, a packet loss rate of the secondary wireless earbud 115-b with the device 110-a, and a link quality of the relay piconet via which the primary wireless earbud 115-a relays missed packets to the secondary wireless earbud 115-b. For example, if the primary wireless earbud 115-a retransmits a relayed packet multiple times, latency may increase.

In some cases, other possible communication difficulties between the wireless earbud 115-a and the wireless earbud 115-b may relate to a data rate protocol implemented by the wireless earbud 115-a and the wireless earbud 115-b, where different data rate protocols may be associated with different bandwidths (e.g., how many channels 225) used for communication between the wireless earbud 115-a and the wireless earbud 115-b. In some aspects, a data rate protocol may be specified or used in accordance with a network specification. Additionally, or alternatively, a data rate protocol may be specific to a manufacturer or a type of product. Further, different data rate protocols may define or otherwise be associated with different modulation and coding scheme (MCS) settings for different channel bandwidths and/or channel conditions. For example, a first data rate protocol may be associated with a first bandwidth and a second data rate protocol may be associated with a second bandwidth. In an example, the first bandwidth associated with the first data rate protocol may be equal to 1 MHz and the second bandwidth associated with the second data rate protocol may be equal to 2 MHz. As such, a channel 225 may refer to or include 1 MHz if the first data rate protocol is used and may refer to or include 2 MHz if the second data rate protocol is used.

In some systems, a network or regulatory constraint may further specify a minimum quantity of channels 225 to be used for communication between the wireless earbud 115-a and the wireless earbud 115-b. In some aspects, such a minimum quantity of channels 225 may be equal to 15 for at least some transmit powers. As such, if the wireless earbud 115-a and the wireless earbud 115-b communicate in accordance with the second data rate protocol, the wireless earbud 115-a and the wireless earbud 115-b may effectively communicate using a minimum of 30 channels 225 (e.g., a minimum of 30 MHz).

Further, the first data rate protocol may (e.g., typically) be associated with a use of 20 channels. As such, the first data rate protocol may involve or otherwise be associated with communication using 20 MHz of bandwidth while the second data rate protocol may involve or otherwise be associated with communication using at least 30 MHz of bandwidth. Due to the manner in which the wireless earbud 115-a and the wireless earbud 115-b select channels 225 for communication, a greater bandwidth usage may be relatively more detrimental in high interference scenarios.

For example, in scenarios in which the interference 215 to the wireless earbud 115-a or the wireless earbud 115-b is relatively high, there may be fewer “good” channels 225 than the minimum quantity of channels 225 (as defined by the network or regulatory constraint) to be used for communication between the wireless earbud 115-a and the wireless earbud 115-b. As described herein, a “good” channel 225 may refer to a channel 225 associated with a relatively low signal strength measurement (such as a receive signal strength indicator (RSSI) measurement), a relatively high signal-to-noise ratio (SNR), a relatively high signal-to-interference-plus-noise ratio (SINR), or any other channel metric associated with relatively lower chances of communication errors. To fulfill the network or regulatory constraint, the wireless earbud 115-a or the wireless earbud 115-b may select at least the minimum quantity of channels 225 for communication between the wireless earbud 115-a and the wireless earbud 115-b in accordance with device-level decisions based on RSSI levels of each channel 225.

For example, one or both of the wireless earbud 115-a and the wireless earbud 115-b may perform a signal strength measurement 220, such as an RSSI-based measurement, to measure, identify, ascertain, or otherwise determine an interference measurement (e.g., an RSSI level) for each of a set of possibly available channels 225 and may select at least the minimum quantity of channels 225 from the set of possibly available channels 225 based on an RSSI level of each channel 225. The wireless earbud 115-a or the wireless earbud 115-b may prioritize channels 225 having an RSSI level below a threshold RSSI level. In some examples, the wireless earbud 115-a or the wireless earbud 115-b may generate a channel map 230 corresponding each channel 225 to an RSSI level and may start by selecting channels 225 having the lowest RSSI levels. For example, the channel map 230 may include an RSSI level for a channel 225-a, an RSSI level for a channel 225-b, and an RSSI level for a channel 225-c. In some aspects, the channel map 230 may include RSSI levels for approximately 79 channels 225.

As such, the wireless earbud 115-a and the wireless earbud 115-b may, in accordance with the network or regulatory constraint, select one or more relatively poorer channels 225 for communication between the wireless earbud 115-a and the wireless earbud 115-b if the quantity of “good” channels 225 (e.g., channels 225 having RSSI levels below the threshold RSSI level) is less than the minimum quantity of channels 225. Accordingly, the chances of communicating using a “good” channel 225 and having an error-free packet may be greater when using fewer channels 225 (e.g., less bandwidth), as the wireless earbud 115-a and the wireless earbud 115-b may focus (e.g., concentrate) communication toward low interference channels 225 with less of a constraint to use potentially high interference channels 225. In an example high interference scenario, the wireless earbud 115-a and the wireless earbud 115-b may use (e.g., hop on) a relatively poor channel 225 roughly more than half of the time. An adaptive frequency hopping (AFH) algorithm may deploy suitably with the inclusion of relatively poorer channels 225, such that the problem may be concentrated to band scans, a channel map provided by the device 110-a, and a channel map selected between the wireless earbud 115-a and the wireless earbud 115-b.

To reduce the likelihood of the wireless earbud 115-a and the wireless earbud 115-b communicating using a high interference channel 225, the wireless earbud 115-a or the wireless earbud 115-b, or both, may employ techniques to reduce or lower down the minimum quantity of channels 225 to be used for communication between the wireless earbud 115-a and the wireless earbud 115-b. For example, if the minimum quantity of channels 225 is reduced from 15 to 8 (such that a minimum of 16 MHz is used instead of 30 MHz when using the second data rate protocol, as 8 channels*2 MHz=16 MHz). In some scenarios, such as in high interference scenarios, reducing the quantity of channels 225 used for communication between the wireless earbud 115-a and the wireless earbud 115-b may ease the data flow in the relay piconet and reduce the packet error rate at the secondary wireless earbud 115-b.

In some cases, however, there may be various factors or subfactors that limit or impact usage of “good” channels, as some techniques for reducing the quantity of channels 225 used for communication between the wireless earbud 115-a and the wireless earbud 115-b may disable “good” channels 225, which may further adversely impact communication performance. For example, some techniques may include “mapping out” (e.g., precluding from potential selection) channels 225 used for advertisements, which may include channels 1, 26, and 79. In some deployments, however, these channels 225 may be seen as “good” in the spectrum. Further, “mapping out” channel 1 may also include “mapping out” channel 2 when the second data rate protocol is used (which uses 2 MHz channels).

Additionally, or alternatively, some techniques may include “mapping out” channel 79, which may be associated with an out-of-band (OOB) transmission (but seen as good in the spectrum in some deployments). Accordingly, channels 1, 2, 25, 26, and 79 may be omitted due to advertising or network constraints. As such, as much as approximately 6 MHz of bandwidth may be lost, as the wireless earbud 115-a and the wireless earbud 115-b may avoid mapping in advertising channels and may avoid omitting channel 79 because of regulatory constraints. Further, any inefficiencies in choosing or selecting “good” channels 225 from a given channel map 230 may adversely impact channel reduction, as sometimes a “good” channel may be inadvertently “mapped out.”

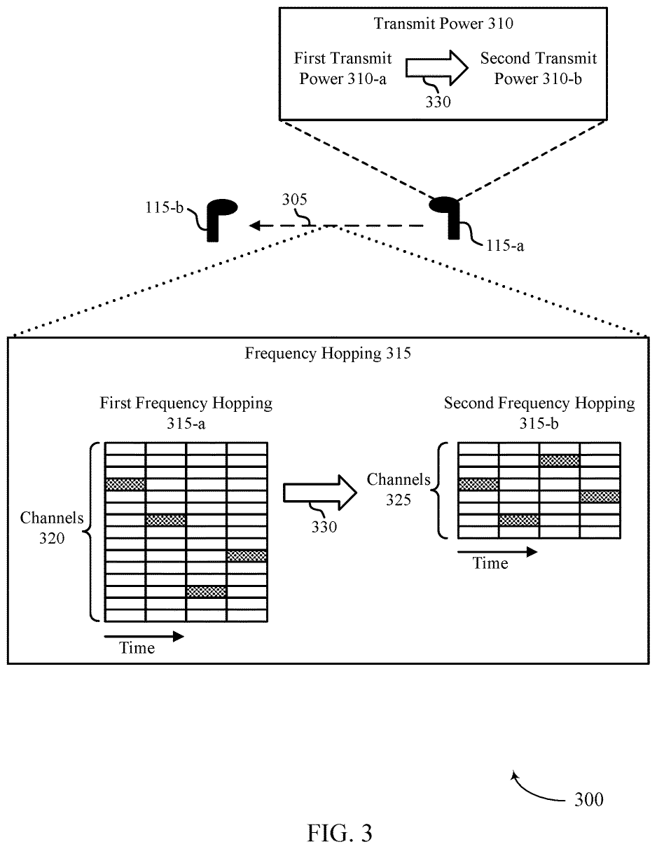

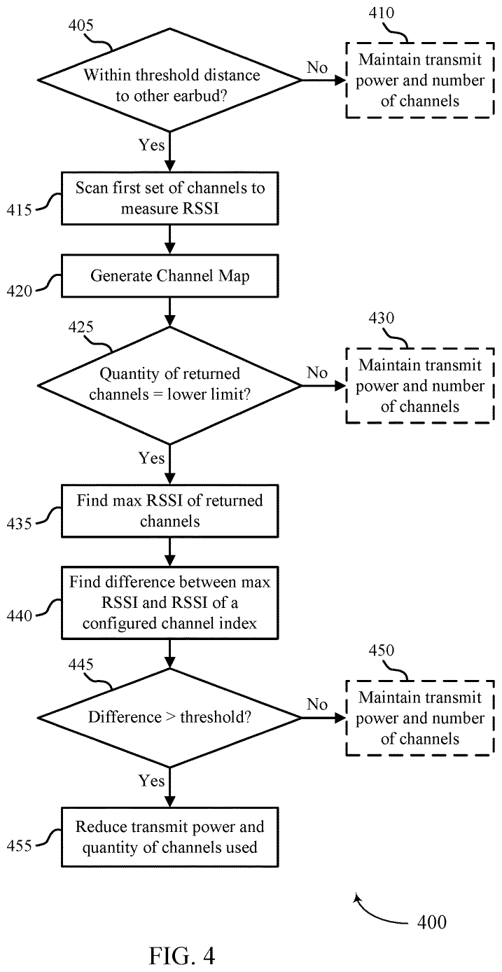

Accordingly, in some implementations, the wireless earbud 115-a and the wireless earbud 115-b may conditionally reduce the minimum channel constraints on the relay piconet between the wireless earbud 115-a and the wireless earbud 115-b to improve communication performance, as the minimum channel constraint may be a large differentiating factor between different data rate protocols (e.g., 2 MHz and 15 channels 225 vs. 1 MHz and 20 channels 225) when it comes to anti-interference performance. As such, the wireless earbud 115-a and the wireless earbud 115-b may hop on low interference channels 225 relatively more often and hop on higher interference channels 225 relatively less often, which may reduce a packet error rate at one or both of the wireless earbud 115-a and the wireless earbud 115-b. Additional details relating to such a conditional reduction in the minimum channel constraints are illustrated by and described with reference to FIGS. 3 and 4.

Further, minimum channel constraints may generally refer to a reduction in the quantity of channels used between any two or more devices. In some implementations, however, the wireless earbud 115-a and the wireless earbud 115-b may employ a reduction in the minimum channel constraints exclusively for the piconet or link between the wireless earbud 115-a and the wireless earbud 115-b and may refrain from reducing the quantity of channels used for communication between the device 110-a and the wireless earbud 115-a. As such, the wireless earbud 115-a and the wireless earbud 115-b may facilitate a more reliable relay link, which may lower latency and the quantity of glitches, as an effort spent to relay packets may be less (due to greater likelihood of early successful reception of a relayed packet).

FIG. 3 illustrates an example communication update 300 that supports techniques for reliable communication between wireless earbuds in a high-interference scenario in accordance with one or more aspects of the present disclosure. The communication update 300 may implement or be implemented to realize aspects of or facilitate the wireless communications system 100 or the user deployment 200. For example, the communication update 300 illustrates communication between the wireless earbud 115-a and the wireless earbud 115-b via a link 305 (which may be associated with a relay piconet), which may be examples of corresponding devices as described herein. In accordance with the communication update 300, the wireless earbud 115-a and the wireless earbud 115-b may update or modify a transmit power 310 and a frequency hopping 315 to reduce an amount of channels used from a set of channels 320 to a set of channels 325.

In some implementations, for example, the wireless earbud 115-a or the wireless earbud 115-b, or both, may employ a selective frequency hopping technique such that the wireless earbud 115-a or the wireless earbud 115-b, or both, avoid hopping on or transmitting using channels that have RSSI levels above a threshold RSSI level. In some implementations, the wireless earbud 115-a or the wireless earbud 115-b may employ such a selective frequency hopping technique when, for example, there are relatively few “good” channels. For example the wireless earbud 115-a or the wireless earbud 115-b may employ such a selective frequency hopping technique when a quantity of channels having RSSI levels below a threshold RSSI level is below a threshold level of channels (e.g., below the minimum quantity of channels expected to be used for communication between the wireless earbud 115-a and the wireless earbud 115-b).

In accordance with such a selective frequency hopping technique, in the topology of the wireless earbud 115-a and the wireless earbud 115-b, a master of the piconet (e.g., the wireless earbud 115-a, the wireless earbud 115-b, a device 110-a as illustrated by and described with reference to FIG. 2, etc.) may configure or instruct the wireless earbud 115-a and the wireless earbud 115-b to avoid hopping on or transmitting using the channels that have RSSI levels above the threshold RSSI level. As such, the wireless earbud 115-a and the wireless earbud 115-b may select a quantity of channels for frequency hopping (e.g., adaptive frequency hopping) in accordance with a network or regulatory constraint (e.g., without reducing a minimum channel constraint), but may skip over transmission opportunities scheduled for channels having relatively higher RSSI levels.

In some aspects, while effective at avoiding interference and maintaining alignment with network or regulatory constraints (without reducing a transmit power), such a skipping of transmission opportunities may result in a loss of two slots each time a sender decides not to transmit using a particular channel, assuming a transmission of a packet to span 3 slots (plus 1 slot for reception) and may be complex to implement. Accordingly, in some implementations, any one or more of the wireless earbud 115-a, the wireless earbud 115-b, or a device 110-a may (e.g., dynamically or statically) select whether or not to employ the selective frequency hopping technique in accordance with a balancing between resource usage efficiency, transmit power considerations, and network or regulatory constraints.

Additionally, or alternatively, the wireless earbud 115-a or the wireless earbud 115-b, or both, may reduce the quantity of channels to be used for communication between the wireless earbud 115-a and the wireless earbud 115-b if a threshold level of interference is measured or otherwise detected. Such a threshold level of interference may be associated with a presence of relatively few “good” channels (e.g., channels with relatively low RSSI measurements) and a relatively large difference between “good” and “bad” channels (in terms of RSSI measurements). Additional details relating to such a measurement or detection of a threshold level of interference is described with reference to FIG. 4.

In such implementations, the wireless earbud 115-a or the wireless earbud 115-b, or both, may perform an update 330 from performing a first frequency hopping 315-a using the set of channels 320 to performing a second frequency hopping 315-b using the reduced set of channels 325. Further, the network or regulatory constraint may specify a minimum of 15 channels (or 30 channels when using the second data rate protocol) when a transmit power 310 is greater than a threshold transmit power (e.g., greater than 10 dBm) and, as such, the wireless earbud 115-a or the wireless earbud 115-b, or both, may perform an update 330 from a first transmit power 310-a to a second transmit power 310-b.

The second transmit power 310-b may be a transmit power that is less than or equal to the threshold transmit power, such as less than or equal to 10 dBm or to approximately just below 10 dBm. Further, in some scenarios, a transmit power of greater than 10 dBm may be unnecessary when the wireless earbud 115-a and the wireless earbud 115-b are hooked in-ear. As such, the wireless earbud 115-a or the wireless earbud 115-b may enable the reduction to the set of channels 325 (by reducing the transmit power 310 to the second transmit power 310-b) without sacrificing link performance. Accordingly, the wireless earbud 115-a or the wireless earbud 115-b, or both, may check channel conditions (e.g., via a signal strength measurement 220, such as an RSSI measurement, of each of a set of possibly available channels) and, if there are relatively few “good” channels available, the wireless earbud 115-a or the wireless earbud 115-b, or both, may reduce a transmit power 310 and the minimum channel constraint (e.g., from 15 channels to 6 channels, from 30 channels to 16 channels, etc.).

FIG. 4 illustrates an example process flow 400 that supports techniques for reliable communication between wireless earbuds in a high-interference scenario in accordance with one or more aspects of the present disclosure. The process flow 400 may implement or be implemented to realize or facilitate aspects of the wireless communications system 100, the user deployment 200, or the communication update 300. For example, the wireless earbud 115-a or the wireless earbud 115-b, which may be examples of corresponding devices as illustrated by and described with reference to FIGS. 1-3, may implement the process flow 400 to reduce or relax a minimum channel constraint in high interference scenarios.

In some implementations, the process flow 400 may be associated with or illustrate an example algorithm according to which a wireless earbud (e.g., the wireless earbud 115-a or the wireless earbud 115-b) may reduce or relax a minimum channel constraint in high interference scenarios. In some examples, the process flow 400 may illustrate an algorithm deployed between the wireless earbud 115-a and the wireless earbud 115-b when using the second data rate protocol (e.g., use of the process flow 400 may be dynamic or otherwise depend on a type of data rate protocol employed by the wireless earbud 115-a and the wireless earbud 115-b).

In the following description of the process flow 400, the operations may be performed (such as reported or provided) in a different order than the order shown, or the operations may be performed in different orders or at different times. For example, specific operations also may be left out of the process flow 400, or other operations may be added to the process flow 400. Further, although some operations or signaling may be shown to occur at different times for discussion purposes, these operations may actually occur at the same time. Further, although described in the context of the wireless earbud 115-a, the wireless earbud 115-b may additionally, or alternatively, perform one or more of the operations of the process flow 400 (e.g., may additionally, or alternatively, perform a subset or an entirety of the operations of the process flow 400).

At 405, the wireless earbud 115-a may perform a signal strength measurement (e.g., an RSSI measurement) of signaling from the wireless earbud 115-b to measure a distance between the wireless earbud 115-a and the wireless earbud 115-b. In some examples, the wireless earbud 115-b may similarly perform a signal strength measurement (e.g., an RSSI measurement) of signaling from the wireless earbud 115-a to measure a distance between the wireless earbud 115-a and the wireless earbud 115-b. For example, the wireless earbud 115-a and the wireless earbud 115-b may measure an RSSI with respect to each other to measure, detect, or ascertain whether the wireless earbud 115-a and the wireless earbud 115-b are proximate to each other (e.g., within a threshold distance of each other, or in-ear of the same user 205). If the wireless earbud 115-a and the wireless earbud 115-b measure that they are within a threshold distance of each other, the wireless earbud 115-a and the wireless earbud 115-b may proceed with performing the other operations of the process flow 400. Otherwise, the wireless earbud 115-a and the wireless earbud 115-b may refrain from performing the other operations of the process flow 400.

At 410, for example, if the wireless earbud 115-a measures, detects, or ascertains that the wireless earbud 115-a and the wireless earbud 115-b are not within a threshold distance of each other, the wireless earbud 115-a may maintain a current or original maximum transmit power and minimum quantity of channels used.

At 415, if the wireless earbud 115-a measures, detects, or ascertains that the wireless earbud 115-a and the wireless earbud 115-b are within a threshold distance of each other, the wireless earbud 115-a may scan or measure a first set of channels to obtain an RSSI measurement for each channel of the first set of channels. For example, the wireless earbud 115-a may perform a signal strength measurement (e.g., an RSSI measurement) across a first set of channels that are available for communications between the wireless earbud 115-a and the wireless earbud 115-b. In some examples, both the wireless earbud 115-a and the wireless earbud 115-b may perform band scans to measure RSSI on, for example, all 79 channels (e.g., as part of an adaptive frequency hopping (AFH) procedure).

At 420, the wireless earbud 115-a may generate a channel map based on or otherwise using the results of the signal strength measurement across the first set of channels. In some implementations, generating the channel map may return a channel map of 15 or more channels, in accordance with a network or regulatory constraint associated with a minimum of 15 channels. For example, the channel map may indicate a subset of channels associated with a lowest level of interference relative to a remainder of the first set of channels and may indicate a respective interference level (e.g., a respective RSSI level) for each of the subset of channels.

At 425, the wireless earbud 115-a may determine or identify whether a quantity of returned channels (from the channel map) is greater than a minimum (e.g., lower limit) quantity of channels. In some implementations, the minimum quantity of channels may be a minimum quantity of channels expected to be used in accordance with a network or regulatory constraint and may be associated with a maximum (e.g., upper limit) transmit power. In some examples, the minimum quantity of channels may be 15 if an initial or original maximum transmit power is greater than or equal to 10 dBm. In such examples, the wireless earbud 115-a may determine or identify whether the quantity of returned channels is greater than or less than 15 channels.

If there are more than 15 channels (or any other lower limit value associated with an initial or original maximum transmit power) returned from the channel map, the wireless earbud 115-a may determine, expect, or ascertain that one or more interference metrics associated with the first set of channels does not satisfy an interference criterion (e.g., that there is less than a threshold amount of interference impacting the first set of channels). If there are exactly 15 channels (or any other lower limit value associated with an initial or original maximum transmit power) returned from the channel map, the wireless earbud 115-a may determine, expect, or ascertain that one or more interference metrics associated with the first set of channels potentially satisfies an interference criterion (e.g., that there may be an interference-related problem impacting the first set of channels). In other words, a channel map algorithm may remove high interference channels until a minimum quantity of channels is reached, which may imply that selected channels are all low interference channels if the channel map returns more than 15 channels or that some selected channels might be high interference channels if the channel map returns exactly 15 channels (as the channel map algorithm may stop removing high interference channels at the 15 channel benchmark).

At 430, for example, if the wireless earbud 115-a determines that the quantity of returned channels is not equal to the lower limit (e.g., such that the quantity of returned channels is greater than the lower limit), the wireless earbud 115-a may maintain a current or original maximum transmit power and minimum quantity of channels used.

At 435, if the wireless earbud 115-a determines that the quantity of returned channels is equal to the lower limit, the wireless earbud 115-a may further inspect the returned channels to determine whether one or more interference metrics associated with the first set of channels satisfies an interference criterion. For example, the wireless earbud 115-a may find, identify, or determine a maximum RSSI of all the channels returned from the channel map. In some aspects, the wireless earbud 115-a may determine that the one or more interference metrics associated with the first set of channels satisfy an interference criterion if the maximum RSSI level is satisfies (e.g., is greater than) a threshold RSSI level. In other words, if the wireless earbud 115-a determines that a greatest interference level of a channel of the subset of channels returned by the channel map satisfies a threshold interference level, the wireless earbud 115-a may determine that the one or more interference metrics associated with the first set of channels satisfy an interference criterion. For example, if the maximum RSSI level of the returned set of channels is −55 dB, the maximum RSSI level may be a strong indicator that at least one of the channels to be used for communication is experiencing a large amount of interference.

At 440, the wireless earbud 115-a may find a difference between the maximum RSSI level and an RSSI level of a channel (e.g., another channel of the subset of channels returned by the channel map) associated with a configurable or fixed channel index. For example, the wireless earbud 115-a may select or be configured to enable at least X channels (where X may be a configurable or fixed number) and may select (e.g., find out) the Xₜₕ channel from the lowest RSSI level. In other words, the wireless earbud 115-a may, by starting at the channel associated with the lowest RSSI level and incrementing, in order, to channels associated with relatively higher RSSI levels, find the X^{th} channel (which may be associated with the X^{th} lowest RSSI level) and may compare the RSSI level associated with the X^{th} channel to the highest RSSI level of the channels returned by the channel map.

In an example, the wireless earbud 115-a may sort 15 returned channels based on RSSI, which may yield an ordered set of RSSI levels (in dBs) of (−55, −56, −57, −58, −70, −75, −80, −81, −82, −85, −85, −87, −90). As such, if X=8 (e.g., if the wireless earbud 115-a selects to enable at least 8 channels), the wireless earbud 115-a may select the 8th channel from the lowest RSSI, which, in this example, may be −75 dB. The wireless earbud 115-a may calculate the difference between −75 dB and −55 dB, which may be equal to 20 dB.

At 445, the wireless earbud 115-a may determine whether the difference is greater than a threshold difference. For example, the wireless earbud 115-a may compare the difference between the highest RSSI level and the X^{th} lowest RSSI level of the channels returned by the channel map to calculate or determine whether the difference is greater than the threshold difference. In an example, the threshold difference may be equal to 12 dB. Accordingly, in the example above in which the difference is equal to 20 dB, the wireless earbud 115-a may determine that the difference is greater than the threshold difference.

At 450, for example, if the wireless earbud 115-a determines that the difference is not greater than the threshold difference, the wireless earbud 115-a may maintain a current or original maximum transmit power and minimum quantity of channels used.

At 455, if the wireless earbud 115-a determines that the difference is greater than the threshold difference, the wireless earbud 115-a may reduce the maximum transmit power and the minimum quantity of channels used for communication between the wireless earbud 115-a and the wireless earbud 115-b. For example, the wireless earbud 115-a may reduce a power such that a maximum transmit power stays below a threshold transmit power, such as below approximately 10 dBm. In accordance with reducing the maximum transmit power to stay below the threshold transmit power, the wireless earbud 115-a may use fewer than the minimum quantity of channels associated with that threshold transmit power. For example, the wireless earbud 115-a may instruct an AFH algorithm to use X channels (or 2X channels if or when the second data rate protocol is used), where X may be less than the minimum quantity of channels (e.g., 15) associated with the threshold transmit power (e.g., 10 dBm). In accordance with an example described herein, X may be set to 8 (e.g., by configuration or in accordance with a fixed value specified by, for example, a network specification).

In some implementations, the wireless earbud 115-a may re-calculate the map using the reduced quantity of X channels. For example, the wireless earbud 115-a may generate an updated channel map that indicates or returns a quantity of X channels that are associated with lowest interference levels (e.g., lowest RSSI levels) relatively to a remainder of the first set of channels. The wireless earbud 115-a may generate the updated map using the signal strength measurements from the previous scan of the first set of channels or in accordance with performing another signal strength measurement for the first set of channels.

The wireless earbud 115-a and the wireless earbud 115-b, and optionally the device 110-a, may coordinate on the reduction in the maximum transmit power and the reduction in the minimum quantity of channels expected to be used for communication between the wireless earbud 115-a and the wireless earbud 115-b. For example, the wireless earbud 115-a and the wireless earbud 115-b may exchange signaling, such as one or more control messages, to indicate or exchange information relating to the reduction in the maximum transmit power and the reduction in the minimum quantity of channels expected to be used for communication between the wireless earbud 115-a and the wireless earbud 115-b.

As such, the wireless earbud 115-a may transmit or receive audio data packets, to or from the wireless earbud 115-b, in accordance with a frequency hopping across the reduced quantity of X channels. Additional details relating to such a frequency hopping are illustrated by and described with reference to FIG. 3. Further, in accordance with performing frequency hopping using the reduced quantity of X channels, the wireless earbud 115-a and the wireless earbud 115-b may trim or exclude high interference channels that may have otherwise been included in the set of channels the wireless earbud 115-a and the wireless earbud 115-b use for communication, which may reduce a packet error rate and an amount of glitches seen at one or both of the wireless earbud 115-a and the wireless earbud 115-b.

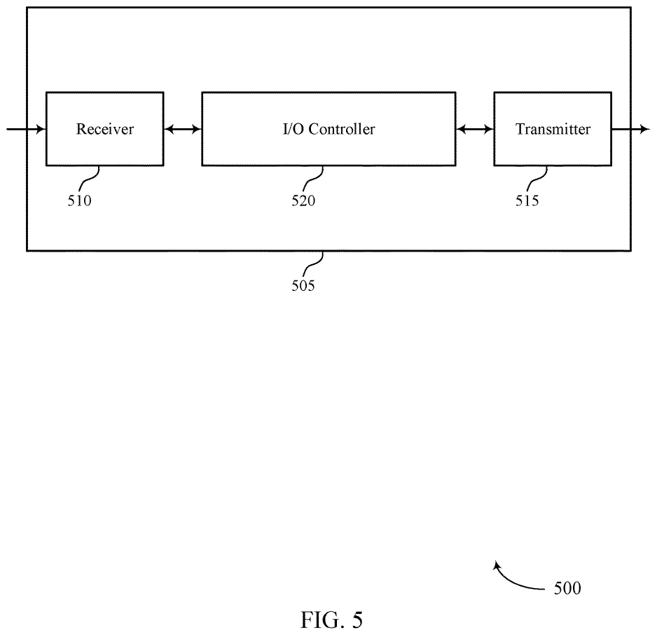

FIG. 5 shows a block diagram 500 of a device 505 that supports techniques for reliable communication between wireless earbuds in a high-interference scenario in accordance with one or more aspects of the present disclosure. The device 505 may be an example of aspects of a Bluetooth Device as described herein. The device 505 may include a receiver 510, a transmitter 515, and an I/O controller 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for reliable communication between wireless earbuds in a high-interference scenario). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for reliable communication between wireless earbuds in a high-interference scenario). In some examples, the transmitter 515 may be co-located with a receiver 510 in a transceiver module. The transmitter 515 may utilize a single antenna or a set of multiple antennas.

The I/O controller 520, the receiver 510, the transmitter 515, or various combinations thereof or various components thereof may be examples of means for performing various aspects of techniques for reliable communication between wireless earbuds in a high-interference scenario as described herein. For example, the I/O controller 520, the receiver 510, the transmitter 515, or various combinations or components thereof may support a method for performing one or more of the functions described herein.

In some examples, the I/O controller 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the I/O controller 520, the receiver 510, the transmitter 515, or various combinations or components thereof may be implemented in code (e.g., as communications management software or firmware) executed by a processor. If implemented in code executed by a processor, the functions of the I/O controller 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the I/O controller 520 may be configured to perform various operations (e.g., receiving, obtaining, monitoring, outputting, transmitting) using or otherwise in cooperation with the receiver 510, the transmitter 515, or both. For example, the I/O controller 520 may receive information from the receiver 510, send information to the transmitter 515, or be integrated in combination with the receiver 510, the transmitter 515, or both to obtain information, output information, or perform various other operations as described herein.

The I/O controller 520 may support wireless communication at a first wireless earbud in accordance with examples as disclosed herein. For example, the I/O controller 520 may be configured as or otherwise support a means for performing a signal strength measurement across a first set of multiple channels that are available for communications between the first wireless earbud and a second wireless earbud. The I/O controller 520 may be configured as or otherwise support a means for detecting that one or more interference metrics associated with the first set of multiple channels satisfy an interference criterion in accordance with the signal strength measurement across the first set of multiple channels. The I/O controller 520 may be configured as or otherwise support a means for reducing an upper limit transmit power for the communications between the first wireless earbud and the second wireless earbud in accordance with the one or more interference metrics satisfying the interference criterion. The I/O controller 520 may be configured as or otherwise support a means for communicating with the second wireless earbud using a frequency hopping across a second set of multiple channels in accordance with reducing the upper limit transmit power, where the second set of multiple channels is a subset of the first set of multiple channels.

By including or configuring the I/O controller 520 in accordance with examples as described herein, the device 505 (e.g., a processor controlling or otherwise coupled with the receiver 510, the transmitter 515, the I/O controller 520, or a combination thereof) may support techniques for reduced processing, reduced power consumption, and more efficient utilization of communication resources.

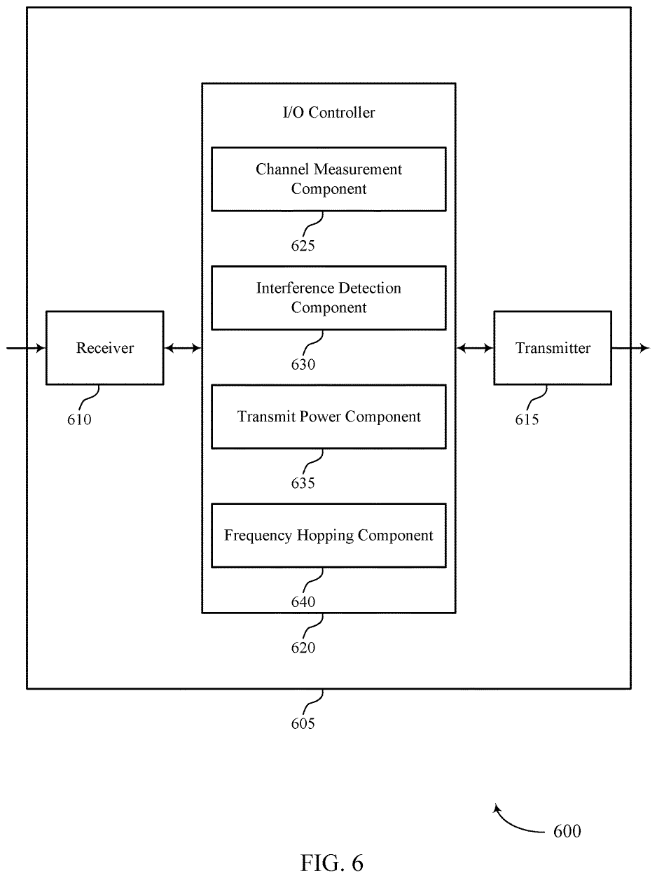

FIG. 6 shows a block diagram 600 of a device 605 that supports techniques for reliable communication between wireless earbuds in a high-interference scenario in accordance with one or more aspects of the present disclosure. The device 605 may be an example of aspects of a device 505 or a paired device 115 as described herein. The device 605 may include a receiver 610, a transmitter 615, and an I/O controller 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for reliable communication between wireless earbuds in a high-interference scenario). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for reliable communication between wireless earbuds in a high-interference scenario). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for reliable communication between wireless earbuds in a high-interference scenario as described herein. For example, the I/O controller 620 may include a channel measurement component 625, an interference detection component 630, a transmit power component 635, a frequency hopping component 640, or any combination thereof. The I/O controller 620 may be an example of aspects of a I/O controller 520 as described herein. In some examples, the I/O controller 620, or various components thereof, may be configured to perform various operations (e.g., receiving, obtaining, monitoring, outputting, transmitting) using or otherwise in cooperation with the receiver 610, the transmitter 615, or both. For example, the I/O controller 620 may receive information from the receiver 610, send information to the transmitter 615, or be integrated in combination with the receiver 610, the transmitter 615, or both to obtain information, output information, or perform various other operations as described herein.

The I/O controller 620 may support wireless communication at a first wireless earbud in accordance with examples as disclosed herein. The channel measurement component 625 may be configured as or otherwise support a means for performing a signal strength measurement across a first set of multiple channels that are available for communications between the first wireless earbud and a second wireless earbud. The interference detection component 630 may be configured as or otherwise support a means for detecting that one or more interference metrics associated with the first set of multiple channels satisfy an interference criterion in accordance with the signal strength measurement across the first set of multiple channels. The transmit power component 635 may be configured as or otherwise support a means for reducing an upper limit transmit power for the communications between the first wireless earbud and the second wireless earbud in accordance with the one or more interference metrics satisfying the interference criterion. The frequency hopping component 640 may be configured as or otherwise support a means for communicating with the second wireless earbud using a frequency hopping across a second set of multiple channels in accordance with reducing the upper limit transmit power, where the second set of multiple channels is a subset of the first set of multiple channels.

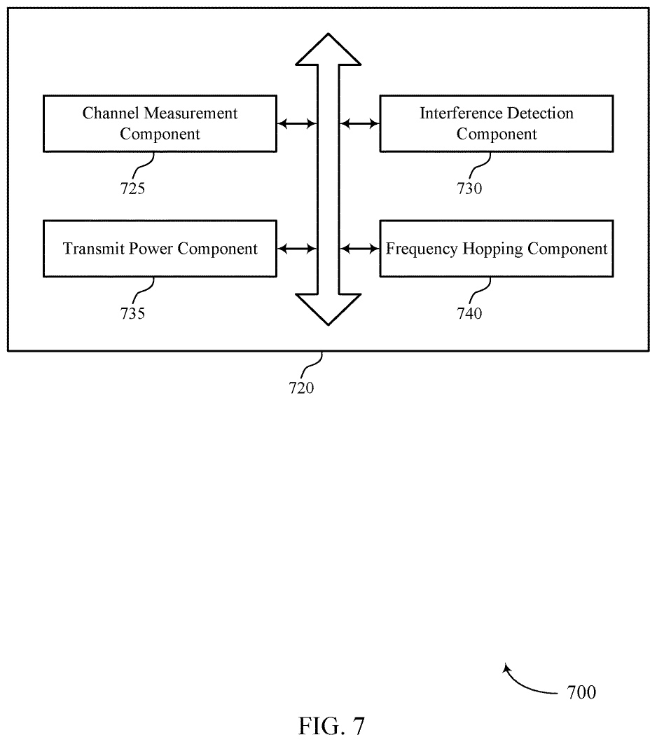

FIG. 7 shows a block diagram 700 of an I/O controller 720 that supports techniques for reliable communication between wireless earbuds in a high-interference scenario in accordance with one or more aspects of the present disclosure. The I/O controller 720 may be an example of aspects of an I/O controller 520, an I/O controller 620, or both, as described herein. The I/O controller 720, or various components thereof, may be an example of means for performing various aspects of techniques for reliable communication between wireless earbuds in a high-interference scenario as described herein. For example, the I/O controller 720 may include a channel measurement component 725, an interference detection component 730, a transmit power component 735, a frequency hopping component 740, or any combination thereof. Each of these components may communicate, directly or indirectly, with one another (e.g., via one or more buses).

The I/O controller 720 may support wireless communication at a first wireless earbud in accordance with examples as disclosed herein. The channel measurement component 725 may be configured as or otherwise support a means for performing a signal strength measurement across a first set of multiple channels that are available for communications between the first wireless earbud and a second wireless earbud. The interference detection component 730 may be configured as or otherwise support a means for detecting that one or more interference metrics associated with the first set of multiple channels satisfy an interference criterion in accordance with the signal strength measurement across the first set of multiple channels. The transmit power component 735 may be configured as or otherwise support a means for reducing an upper limit transmit power for the communications between the first wireless earbud and the second wireless earbud in accordance with the one or more interference metrics satisfying the interference criterion. The frequency hopping component 740 may be configured as or otherwise support a means for communicating with the second wireless earbud using a frequency hopping across a second set of multiple channels in accordance with reducing the upper limit transmit power, where the second set of multiple channels is a subset of the first set of multiple channels.

In some examples, the channel measurement component 725 may be configured as or otherwise support a means for generating a channel map based on the signal strength measurement across the first set of multiple channels, where the channel map indicates a third set of multiple channels associated with a lowest level of interference relative to a remainder of the first set of multiple channels and indicates a respective interference level for each of the third set of multiple channels, and where detecting that the one or more interference metrics satisfy the interference criterion is based on generating the channel map.

In some examples, to support detecting that the one or more interference metrics satisfy the interference criterion, the interference detection component 730 may be configured as or otherwise support a means for ordering the third set of multiple channels into a sequence in accordance with the respective interference level for each of the third set of multiple channels. In some examples, to support detecting that the one or more interference metrics satisfy the interference criterion, the interference detection component 730 may be configured as or otherwise support a means for calculating a difference between a greatest interference level of the third set of multiple channels and an interference level of a channel of the third set of multiple channels that is associated with a configurable index value into the sequence.

In some examples, the one or more interference metrics satisfy the interference criterion in accordance with the difference satisfying a threshold difference.

In some examples, to support detecting that the one or more interference metrics satisfy the interference criterion, the interference detection component 730 may be configured as or otherwise support a means for determining that a greatest interference level of a channel of the third set of multiple channels satisfies a threshold interference level.

In some examples, to support detecting that the one or more interference metrics satisfy the interference criterion, the interference detection component 730 may be configured as or otherwise support a means for determining that a quantity of the third set of multiple channels is equal to a lower limit quantity associated with an initial transmit power.

In some examples, the frequency hopping component 740 may be configured as or otherwise support a means for indicating an adaptive frequency hopping algorithm to use the second set of multiple channels in accordance with the one or more interference metrics satisfying the interference criterion, where the second set of multiple channels is a subset of the third set of multiple channels. In some examples, the channel measurement component 725 may be configured as or otherwise support a means for generating a second channel map based on the signal strength measurement across the first set of multiple channels, where the channel map indicates that the second set of multiple channels are associated with the lowest level of interference relative to the remainder of the first set of multiple channels.

In some examples, to support reducing the upper limit transmit power, the transmit power component 735 may be configured as or otherwise support a means for reducing the upper limit transmit power from a first value associated with a first lower limit quantity of channels for the communications between the first wireless earbud and the second wireless earbud to a second value associated with a second lower limit quantity of channels for the communications between the first wireless earbud and the second wireless earbud, where the second lower limit quantity of channels is less than the first lower limit quantity of channels.

In some examples, the channel measurement component 725 may be configured as or otherwise support a means for performing a second signal strength measurement of signaling from the second wireless earbud to measure a distance between the first wireless earbud and the second wireless earbud, where detecting that the one or more interference metrics satisfy the interference criterion and reducing the upper limit transmit power are based on the first wireless earbud and the second wireless earbud being within a threshold distance of each other.

In some examples, to support communicating with the second wireless earbud using the frequency hopping across the second set of multiple channels, the frequency hopping component 740 may be configured as or otherwise support a means for transmitting or receiving audio data packets, to or from the second wireless earbud, in accordance with the frequency hopping across the second set of multiple channels.

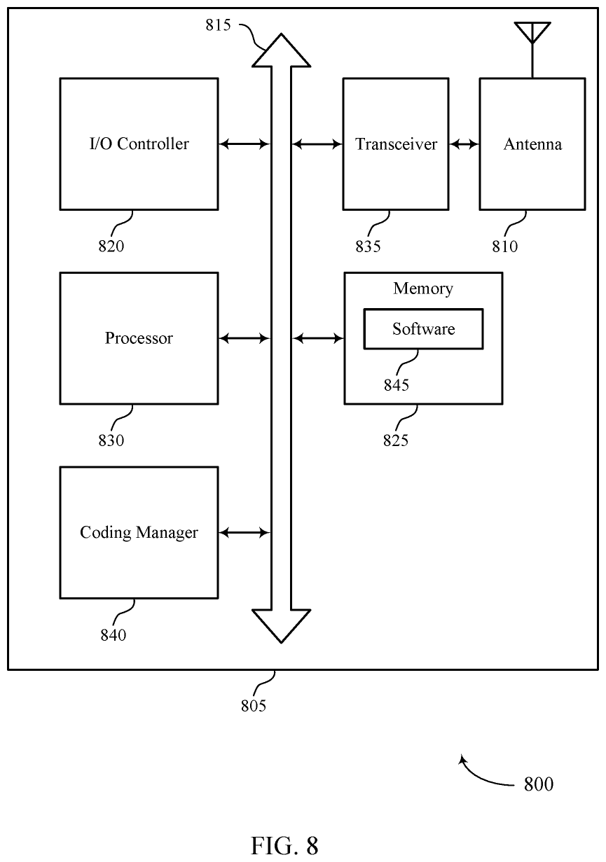

FIG. 8 shows a diagram of a system 800 including a device 805 that supports techniques for reliable communication between wireless earbuds in a high-interference scenario in accordance with one or more aspects of the present disclosure. The device 805 may be an example of or include the components of a device 505, a device 605, or a Bluetooth Device as described herein. The device 805 may include components for bi-directional voice and data communications including components for transmitting and receiving communications, such as an I/O controller 820, an antenna 810, a memory 825, a processor 830, a transceiver 835, a coding manager 840, and a software 845. These components may be in electronic communication or otherwise coupled (e.g., operatively, communicatively, functionally, electronically, electrically) via one or more buses (e.g., a bus 815).

The memory 825 may include RAM and ROM. The memory 825 may store software 845 including instructions that, when executed by the processor 830, cause the device 805 to perform various functions described herein. The software 845 may be stored in a non-transitory computer-readable medium such as system memory or other type of memory. In some cases, the software 845 may not be directly executable by the processor 830 but may cause a computer (e.g., when compiled and executed) to perform functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In some other cases, a memory controller may be integrated into the processor 830. The processor 830 may be configured to execute computer-readable instructions stored in a memory (e.g., the memory 825) to cause the device 805 to perform various functions (e.g., functions or tasks supporting techniques for reliable communication between wireless earbuds in a high-interference scenario). For example, the device 805 or a component of the device 805 may include a processor 830 and memory 825 coupled with or to the processor 830, the processor 830 and memory 825 configured to perform various functions described herein.

In some cases, the device 805 may include a single antenna 810. However, in some other cases the device 805 may have more than one antenna 810, which may be capable of concurrently transmitting or receiving multiple wireless transmissions. The transceiver 835 may communicate bi-directionally, via the one or more antennas 810, wired, or wireless links as described herein. For example, the transceiver 835 may represent a wireless transceiver and may communicate bi-directionally with another wireless transceiver. The transceiver 835 may also include a modem to modulate the packets and provide the modulated packets to one or more antennas 810 for transmission, and to demodulate packets received from the one or more antennas 810.

The transceiver 835, or the transceiver 835 and one or more antennas 810, may be an example of a transmitter 515, a transmitter 615, a receiver 510, a receiver 610, or any combination thereof or component thereof, as described herein.

The software 845 may include instructions to implement aspects of the present disclosure, including instructions to support techniques for reliable communication between wireless earbuds in a high-interference scenario. The software 845 may be stored in a non-transitory computer-readable medium such as system memory or other type of memory. In some cases, the software 845 may not be directly executable by the processor 830 but may cause a computer (e.g., when compiled and executed) to perform functions described herein.

The I/O controller 820 may support wireless communication at a first wireless earbud in accordance with examples as disclosed herein. For example, the I/O controller 820 may be configured as or otherwise support a means for performing a signal strength measurement across a first set of multiple channels that are available for communications between the first wireless earbud and a second wireless earbud. The I/O controller 820 may be configured as or otherwise support a means for detecting that one or more interference metrics associated with the first set of multiple channels satisfy an interference criterion in accordance with the signal strength measurement across the first set of multiple channels. The I/O controller 820 may be configured as or otherwise support a means for reducing an upper limit transmit power for the communications between the first wireless earbud and the second wireless earbud in accordance with the one or more interference metrics satisfying the interference criterion. The I/O controller 820 may be configured as or otherwise support a means for communicating with the second wireless earbud using a frequency hopping across a second set of multiple channels in accordance with reducing the upper limit transmit power, where the second set of multiple channels is a subset of the first set of multiple channels.

By including or configuring the I/O controller 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

I/O controller 820 may manage input and output signals for the device 805. I/O controller 820 may also manage peripherals not integrated into the device 805. In some cases, I/O controller 820 may represent a physical connection or port to an external peripheral. In some cases, I/O controller 820 may utilize an operating system such as iOS®, ANDROID®, MS-DOS®, MS-WINDOWS®, OS/2®, UNIX®, LINUX®, or another known operating system. In other cases, I/O controller 820 may represent or interact with a modem, a keyboard, a mouse, a touchscreen, or a similar device. In some cases, I/O controller 820 may be implemented as part of a processor, such as the processor 830. In some cases, a user may interact with the device 805 via I/O controller 820 or via hardware components controlled by I/O controller 820.

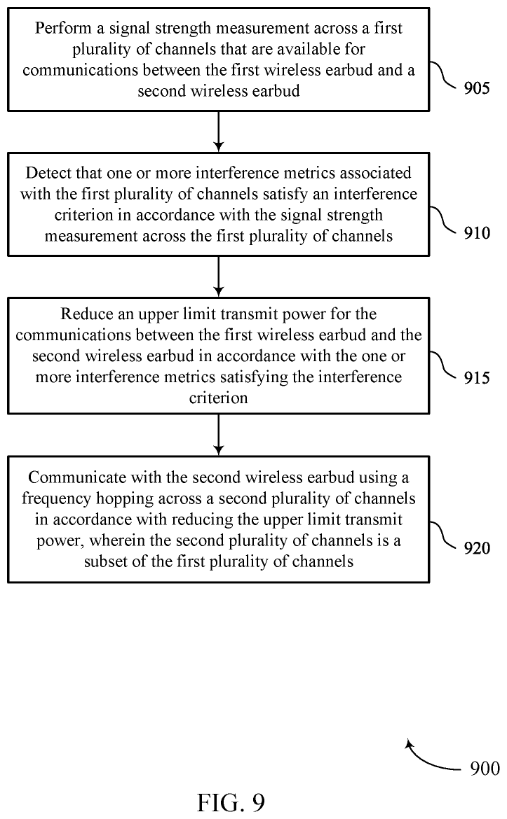

FIG. 9 shows a flowchart illustrating a method 900 that supports techniques for reliable communication between wireless earbuds in a high-interference scenario in accordance with one or more aspects of the present disclosure. The operations of the method 900 may be implemented by a Bluetooth Device or its components as described herein. For example, the operations of the method 900 may be performed by a Bluetooth Device as described with reference to FIGS. 1 through 8. In some examples, a Bluetooth Device may execute a set of instructions to control the functional elements of the Bluetooth Device to perform the described functions. Additionally, or alternatively, the Bluetooth Device may perform aspects of the described functions using special-purpose hardware.

At 905, the method may include performing a signal strength measurement across a first set of multiple channels that are available for communications between the first wireless earbud and a second wireless earbud. The operations of 905 may be performed in accordance with examples as disclosed herein. In some examples, aspects of the operations of 905 may be performed by a channel measurement component 725 as described with reference to FIG. 7.

At 910, the method may include detecting that one or more interference metrics associated with the first set of multiple channels satisfy an interference criterion in accordance with the signal strength measurement across the first set of multiple channels. The operations of 910 may be performed in accordance with examples as disclosed herein. In some examples, aspects of the operations of 910 may be performed by an interference detection component 730 as described with reference to FIG. 7.

At 915, the method may include reducing an upper limit transmit power for the communications between the first wireless earbud and the second wireless earbud in accordance with the one or more interference metrics satisfying the interference criterion. The operations of 915 may be performed in accordance with examples as disclosed herein. In some examples, aspects of the operations of 915 may be performed by a transmit power component 735 as described with reference to FIG. 7.

At 920, the method may include communicating with the second wireless earbud using a frequency hopping across a second set of multiple channels in accordance with reducing the upper limit transmit power, where the second set of multiple channels is a subset of the first set of multiple channels. The operations of 920 may be performed in accordance with examples as disclosed herein. In some examples, aspects of the operations of 920 may be performed by a frequency hopping component 740 as described with reference to FIG. 7.

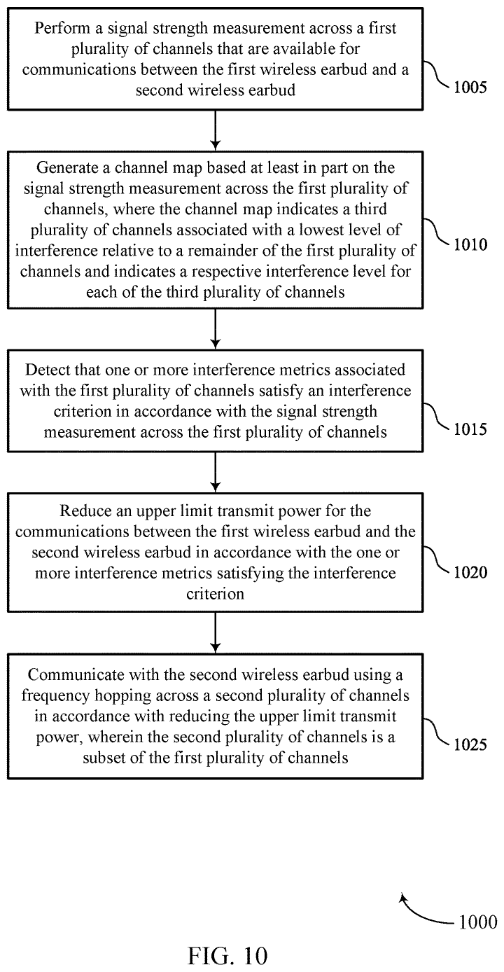

FIG. 10 shows a flowchart illustrating a method 1000 that supports techniques for reliable communication between wireless earbuds in a high-interference scenario in accordance with one or more aspects of the present disclosure. The operations of the method 1000 may be implemented by a Bluetooth Device or its components as described herein. For example, the operations of the method 1000 may be performed by a Bluetooth Device as described with reference to FIGS. 1 through 8. In some examples, a Bluetooth Device may execute a set of instructions to control the functional elements of the Bluetooth Device to perform the described functions.

Additionally, or alternatively, the Bluetooth Device may perform aspects of the described functions using special-purpose hardware.

At 1005, the method may include performing a signal strength measurement across a first set of multiple channels that are available for communications between the first wireless earbud and a second wireless earbud. The operations of 1005 may be performed in accordance with examples as disclosed herein. In some examples, aspects of the operations of 1005 may be performed by a channel measurement component 725 as described with reference to FIG. 7.

At 1010, the method may include generating a channel map based on the signal strength measurement across the first set of multiple channels, where the channel map indicates a third set of multiple channels associated with a lowest level of interference relative to a remainder of the first set of multiple channels and indicates a respective interference level for each of the third set of multiple channels. The operations of 1010 may be performed in accordance with examples as disclosed herein. In some examples, aspects of the operations of 1010 may be performed by a channel measurement component 725 as described with reference to FIG. 7.

At 1015, the method may include detecting that one or more interference metrics associated with the first set of multiple channels satisfy an interference criterion in accordance with the signal strength measurement across the first set of multiple channels. The operations of 1015 may be performed in accordance with examples as disclosed herein. In some examples, aspects of the operations of 1015 may be performed by an interference detection component 730 as described with reference to FIG. 7.

At 1020, the method may include reducing an upper limit transmit power for the communications between the first wireless earbud and the second wireless earbud in accordance with the one or more interference metrics satisfying the interference criterion. The operations of 1020 may be performed in accordance with examples as disclosed herein. In some examples, aspects of the operations of 1020 may be performed by a transmit power component 735 as described with reference to FIG. 7.

At 1025, the method may include communicating with the second wireless earbud using a frequency hopping across a second set of multiple channels in accordance with reducing the upper limit transmit power, where the second set of multiple channels is a subset of the first set of multiple channels. The operations of 1025 may be performed in accordance with examples as disclosed herein. In some examples, aspects of the operations of 1025 may be performed by a frequency hopping component 740 as described with reference to FIG. 7.

The following provides an overview of some aspects of the present disclosure:

Aspect 1: A method for wireless communication at a first wireless earbud, comprising: performing a signal strength measurement across a first plurality of channels that are available for communications between the first wireless earbud and a second wireless earbud; detecting that one or more interference metrics associated with the first plurality of channels satisfy an interference criterion in accordance with the signal strength measurement across the first plurality of channels; reducing an upper limit transmit power for the communications between the first wireless earbud and the second wireless earbud in accordance with the one or more interference metrics satisfying the interference criterion; and communicating with the second wireless earbud using a frequency hopping across a second plurality of channels in accordance with reducing the upper limit transmit power, wherein the second plurality of channels is a subset of the first plurality of channels.

Aspect 2: The method of aspect 1, further comprising: generating a channel map based at least in part on the signal strength measurement across the first plurality of channels, wherein the channel map indicates a third plurality of channels associated with a lowest level of interference relative to a remainder of the first plurality of channels and indicates a respective interference level for each of the third plurality of channels, and wherein detecting that the one or more interference metrics satisfy the interference criterion is based at least in part on generating the channel map.

Aspect 3: The method of aspect 2, wherein detecting that the one or more interference metrics satisfy the interference criterion comprises: ordering the third plurality of channels into a sequence in accordance with the respective interference level for each of the third plurality of channels; and calculating a difference between a greatest interference level of the third plurality of channels and an interference level of a channel of the third plurality of channels that is associated with a configurable index value into the sequence.

Aspect 4: The method of aspect 3, wherein the one or more interference metrics satisfy the interference criterion in accordance with the difference satisfying a threshold difference.

Aspect 5: The method of any of aspects 2 through 4, wherein detecting that the one or more interference metrics satisfy the interference criterion comprises: determining that a greatest interference level of a channel of the third plurality of channels satisfies a threshold interference level.

Aspect 6: The method of any of aspects 2 through 5, wherein detecting that the one or more interference metrics satisfy the interference criterion comprises: determining that a quantity of the third plurality of channels is equal to a lower limit quantity associated with an initial transmit power.

Aspect 7: The method of any of aspects 2 through 6, further comprising: indicating an adaptive frequency hopping algorithm to use the second plurality of channels in accordance with the one or more interference metrics satisfying the interference criterion, wherein the second plurality of channels is a subset of the third plurality of channels; and generating a second channel map based at least in part on the signal strength measurement across the first plurality of channels, wherein the channel map indicates that the second plurality of channels are associated with the lowest level of interference relative to the remainder of the first plurality of channels.

Aspect 8: The method of any of aspects 1 through 7, wherein reducing the upper limit transmit power comprises: reducing the upper limit transmit power from a first value associated with a first lower limit quantity of channels for the communications between the first wireless earbud and the second wireless earbud to a second value associated with a second lower limit quantity of channels for the communications between the first wireless earbud and the second wireless earbud, wherein the second lower limit quantity of channels is less than the first lower limit quantity of channels.

Aspect 9: The method of any of aspects 1 through 8, further comprising: performing a second signal strength measurement of signaling from the second wireless earbud to measure a distance between the first wireless earbud and the second wireless earbud, wherein detecting that the one or more interference metrics satisfy the interference criterion and reducing the upper limit transmit power are based at least in part on the first wireless earbud and the second wireless earbud being within a threshold distance of each other.

Aspect 10: The method of any of aspects 1 through 9, wherein communicating with the second wireless earbud using the frequency hopping across the second plurality of channels comprises: transmitting or receiving audio data packets, to or from the second wireless earbud, in accordance with the frequency hopping across the second plurality of channels.

Aspect 11: An apparatus for wireless communication at a first wireless earbud, comprising a processor; memory coupled with the processor; and instructions stored in the memory and executable by the processor to cause the apparatus to perform a method of any of aspects 1 through 10.

Aspect 12: An apparatus for wireless communication at a first wireless earbud, comprising at least one means for performing a method of any of aspects 1 through 10.

Aspect 13: A non-transitory computer-readable medium storing code for wireless communication at a first wireless earbud, the code comprising instructions executable by a processor to perform a method of any of aspects 1 through 10.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a first wireless earbud, comprising:
a processor;
memory coupled with the processor; and
instructions stored in the memory and executable by the processor to cause the apparatus to:
perform a signal strength measurement across a first plurality of channels that are available for communications between the first wireless earbud and a second wireless earbud;
detect that one or more interference metrics associated with the first plurality of channels satisfy an interference criterion in accordance with the signal strength measurement across the first plurality of channels;
reduce an upper limit transmit power for the communications between the first wireless earbud and the second wireless earbud in accordance with the one or more interference metrics satisfying the interference criterion; and
communicate with the second wireless earbud using a frequency hopping across a second plurality of channels in accordance with reducing the upper limit transmit power, wherein the second plurality of channels is a subset of the first plurality of channels.

2. The apparatus of claim 1, wherein the instructions are further executable by the processor to cause the apparatus to:
generate a channel map based at least in part on the signal strength measurement across the first plurality of channels, wherein the channel map indicates a third plurality of channels associated with a lowest level of interference relative to a remainder of the first plurality of channels and indicates a respective interference level for each of the third plurality of channels, and wherein detecting that the one or more interference metrics satisfy the interference criterion is based at least in part on generating the channel map.

3. The apparatus of claim 2, wherein the instructions to detect that the one or more interference metrics satisfy the interference criterion are executable by the processor to cause the apparatus to:
order the third plurality of channels into a sequence in accordance with the respective interference level for each of the third plurality of channels; and
calculate a difference between a greatest interference level of the third plurality of channels and an interference level of a channel of the third plurality of channels that is associated with a configurable index value into the sequence.

4. The apparatus of claim 3, wherein the one or more interference metrics satisfy the interference criterion in accordance with the difference satisfying a threshold difference.

5. The apparatus of claim 2, wherein the instructions to detect that the one or more interference metrics satisfy the interference criterion are executable by the processor to cause the apparatus to:
determine that a greatest interference level of a channel of the third plurality of channels satisfies a threshold interference level.

6. The apparatus of claim 2, wherein the instructions to detect that the one or more interference metrics satisfy the interference criterion are executable by the processor to cause the apparatus to:
determine that a quantity of the third plurality of channels is equal to a lower limit quantity associated with an initial transmit power.

7. The apparatus of claim 2, wherein the instructions are further executable by the processor to cause the apparatus to:
indicate an adaptive frequency hopping algorithm to use the second plurality of channels in accordance with the one or more interference metrics satisfying the interference criterion, wherein the second plurality of channels is a subset of the third plurality of channels; and
generate a second channel map based at least in part on the signal strength measurement across the first plurality of channels, wherein the channel map indicates that the second plurality of channels are associated with the lowest level of interference relative to the remainder of the first plurality of channels.

8. The apparatus of claim 1, wherein the instructions to reduce the upper limit transmit power are executable by the processor to cause the apparatus to:
reduce the upper limit transmit power from a first value associated with a first lower limit quantity of channels for the communications between the first wireless earbud and the second wireless earbud to a second value associated with a second lower limit quantity of channels for the communications between the first wireless earbud and the second wireless earbud, wherein the second lower limit quantity of channels is less than the first lower limit quantity of channels.

9. The apparatus of claim 1, wherein the instructions are further executable by the processor to cause the apparatus to:
perform a second signal strength measurement of signaling from the second wireless earbud to measure a distance between the first wireless earbud and the second wireless earbud, wherein detecting that the one or more interference metrics satisfy the interference criterion and reducing the upper limit transmit power are based at least in part on the first wireless earbud and the second wireless earbud being within a threshold distance of each other.

10. The apparatus of claim 1, wherein the instructions to communicate with the second wireless earbud using the frequency hopping across the second plurality of channels are executable by the processor to cause the apparatus to:
transmit or receive audio data packets, to or from the second wireless earbud, in accordance with the frequency hopping across the second plurality of channels.

11. A method for wireless communication at a first wireless earbud, comprising:
performing a signal strength measurement across a first plurality of channels that are available for communications between the first wireless earbud and a second wireless earbud;
detecting that one or more interference metrics associated with the first plurality of channels satisfy an interference criterion in accordance with the signal strength measurement across the first plurality of channels;
reducing an upper limit transmit power for the communications between the first wireless earbud and the second wireless earbud in accordance with the one or more interference metrics satisfying the interference criterion; and
communicating with the second wireless earbud using a frequency hopping across a second plurality of channels in accordance with reducing the upper limit transmit power, wherein the second plurality of channels is a subset of the first plurality of channels.

12. The method of claim 11, further comprising:
generating a channel map based at least in part on the signal strength measurement across the first plurality of channels, wherein the channel map indicates a third plurality of channels associated with a lowest level of interference relative to a remainder of the first plurality of channels and indicates a respective interference level for each of the third plurality of channels, and wherein detecting that the one or more interference metrics satisfy the interference criterion is based at least in part on generating the channel map.

13. The method of claim 12, wherein detecting that the one or more interference metrics satisfy the interference criterion comprises:
ordering the third plurality of channels into a sequence in accordance with the respective interference level for each of the third plurality of channels; and
calculating a difference between a greatest interference level of the third plurality of channels and an interference level of a channel of the third plurality of channels that is associated with a configurable index value into the sequence.

14. The method of claim 13, wherein the one or more interference metrics satisfy the interference criterion in accordance with the difference satisfying a threshold difference.

15. The method of claim 12, wherein detecting that the one or more interference metrics satisfy the interference criterion comprises:
determining that a greatest interference level of a channel of the third plurality of channels satisfies a threshold interference level.

16. The method of claim 12, wherein detecting that the one or more interference metrics satisfy the interference criterion comprises:
determining that a quantity of the third plurality of channels is equal to a lower limit quantity associated with an initial transmit power.

17. The method of claim 12, further comprising:
indicating an adaptive frequency hopping algorithm to use the second plurality of channels in accordance with the one or more interference metrics satisfying the interference criterion, wherein the second plurality of channels is a subset of the third plurality of channels; and
generating a second channel map based at least in part on the signal strength measurement across the first plurality of channels, wherein the channel map indicates that the second plurality of channels are associated with the lowest level of interference relative to the remainder of the first plurality of channels.

18. The method of claim 11, wherein reducing the upper limit transmit power comprises:
reducing the upper limit transmit power from a first value associated with a first lower limit quantity of channels for the communications between the first wireless earbud and the second wireless earbud to a second value associated with a second lower limit quantity of channels for the communications between the first wireless earbud and the second wireless earbud, wherein the second lower limit quantity of channels is less than the first lower limit quantity of channels.

19. The method of claim 11, further comprising:
performing a second signal strength measurement of signaling from the second wireless earbud to measure a distance between the first wireless earbud and the second wireless earbud, wherein detecting that the one or more interference metrics satisfy the interference criterion and reducing the upper limit transmit power are based at least in part on the first wireless earbud and the second wireless earbud being within a threshold distance of each other.

20. The method of claim 11, wherein communicating with the second wireless earbud using the frequency hopping across the second plurality of channels comprises:
transmitting or receiving audio data packets, to or from the second wireless earbud, in accordance with the frequency hopping across the second plurality of channels.

21. An apparatus for wireless communication at a first wireless earbud, comprising:
means for performing a signal strength measurement across a first plurality of channels that are available for communications between the first wireless earbud and a second wireless earbud;
means for detecting that one or more interference metrics associated with the first plurality of channels satisfy an interference criterion in accordance with the signal strength measurement across the first plurality of channels;
means for reducing an upper limit transmit power for the communications between the first wireless earbud and the second wireless earbud in accordance with the one or more interference metrics satisfying the interference criterion; and
means for communicating with the second wireless earbud using a frequency hopping across a second plurality of channels in accordance with reducing the upper limit transmit power, wherein the second plurality of channels is a subset of the first plurality of channels.

22. The apparatus of claim 21, further comprising:
means for generating a channel map based at least in part on the signal strength measurement across the first plurality of channels, wherein the channel map indicates a third plurality of channels associated with a lowest level of interference relative to a remainder of the first plurality of channels and indicates a respective interference level for each of the third plurality of channels, and wherein detecting that the one or more interference metrics satisfy the interference criterion is based at least in part on generating the channel map.

23. The apparatus of claim 22, wherein the means for detecting that the one or more interference metrics satisfy the interference criterion comprise:
means for ordering the third plurality of channels into a sequence in accordance with the respective interference level for each of the third plurality of channels; and
means for calculating a difference between a greatest interference level of the third plurality of channels and an interference level of a channel of the third plurality of channels that is associated with a configurable index value into the sequence.

24. The apparatus of claim 23, wherein the one or more interference metrics satisfy the interference criterion in accordance with the difference satisfying a threshold difference.

25. The apparatus of claim 22, wherein the means for detecting that the one or more interference metrics satisfy the interference criterion comprise:
means for determining that a greatest interference level of a channel of the third plurality of channels satisfies a threshold interference level.

26. The apparatus of claim 22, wherein the means for detecting that the one or more interference metrics satisfy the interference criterion comprise:
means for determining that a quantity of the third plurality of channels is equal to a lower limit quantity associated with an initial transmit power.

27. The apparatus of claim 22, further comprising:
means for indicating an adaptive frequency hopping algorithm to use the second plurality of channels in accordance with the one or more interference metrics satisfying the interference criterion, wherein the second plurality of channels is a subset of the third plurality of channels; and
means for generating a second channel map based at least in part on the signal strength measurement across the first plurality of channels, wherein the channel map indicates that the second plurality of channels are associated with the lowest level of interference relative to the remainder of the first plurality of channels.

28. The apparatus of claim 21, wherein the means for reducing the upper limit transmit power comprise:
means for reducing the upper limit transmit power from a first value associated with a first lower limit quantity of channels for the communications between the first wireless earbud and the second wireless earbud to a second value associated with a second lower limit quantity of channels for the communications between the first wireless earbud and the second wireless earbud, wherein the second lower limit quantity of channels is less than the first lower limit quantity of channels.

29. The apparatus of claim 21, further comprising:
means for performing a second signal strength measurement of signaling from the second wireless earbud to measure a distance between the first wireless earbud and the second wireless earbud, wherein detecting that the one or more interference metrics satisfy the interference criterion and reducing the upper limit transmit power are based at least in part on the first wireless earbud and the second wireless earbud being within a threshold distance of each other.

30. A non-transitory computer-readable medium storing code for wireless communication at a first wireless earbud, the code comprising instructions executable by a processor to:
perform a signal strength measurement across a first plurality of channels that are available for communications between the first wireless earbud and a second wireless earbud;
detect that one or more interference metrics associated with the first plurality of channels satisfy an interference criterion in accordance with the signal strength measurement across the first plurality of channels;
reduce an upper limit transmit power for the communications between the first wireless earbud and the second wireless earbud in accordance with the one or more interference metrics satisfying the interference criterion; and
communicate with the second wireless earbud using a frequency hopping across a second plurality of channels in accordance with reducing the upper limit transmit power, wherein the second plurality of channels is a subset of the first plurality of channels.
